(19) United States
(12) Patent Application Publication
(10) Pub. No.: US 2006/0282653 A1
(43) Pub. Date: Dec. 14, 2006

(54) Method for updating frimware of memory card

(76) Inventors: Ping-Ying Chu, Hsinchu (TW); Chien-Chih Liu, Hsinchu (TW)

Correspondence Address: J.C. Patents, Inc., Suite 250, 4 Venture, Irvine, CA, 92618, US

(21) Appl. No.: 11/360,247

(22) Filed: Feb. 22, 2006

(30) Foreign Application Priority Data
Jun. 8, 2005 (TW) 94118855

(51) Int. Cl. G06F 15/177; G06F 9/24

(52) U.S. Cl. 713/1

(57) ABSTRACT

A method for updating a firmware of a memory card is provided. The method includes: first, starting the memory card; then, determining whether there is a new firmware code or not in the nonvolatile memory; if it is determined that there is a new firmware code in the nonvolatile memory, then determining whether the new firmware code has been updated; if it is determined that the new firmware code has not been updated yet, then performing the firmware updating, and then performing the general operating procedure of the memory card. Therefore, instead of returning back to the memory card manufacturer, the user can conveniently update the memory card with a PC or a card reader.

### CROSS-REFERENCE TO RELATED APPLICATION

This application claims the priority benefit of Taiwan application serial. no. 94118855, filed on Jun. 8, 2005. All disclosure of the Taiwan application is incorporated herein by reference.

### BACKGROUND OF THE INVENTION

1. Field of the Invention

The present invention relates to a method for updating a firmware of a memory card, and particularly to a method for updating a firmware of a memory card, by which the user can update the memory card using a PC or a card reader.

2. Description of Related Art

With continuous development in the information technology, storage media (also referred to as portable memory card, flash memory card or memory card) based on the semiconductor technology has become a mainstream product in the IT market. Compared with the conventional storage media including soft disks and optical disks, the portable memory cards have competitive advantages such as portability, low power consumption, data storage, data transmission speed, repetitive reading/writing, shock-proof and moisture-proof. Due to such advantages, portable memory cards are continuously developed and explored by international electronic product manufacturers, which introduce newly developed portable memory cards such as smart card, PCMCIA ATA flash (PC) card, compact flash (CF) card, smart media (SM) card, multimedia card (MMC), memory stick (MS) card, secure digital (SD) card. The cards are used extensively in the newly developed digital products.

Generally, a memory card has a nonvolatile memory disposed inside for storing the data. FIG. 5 is a schematic structural diagram of a conventional nonvolatile memory.

Referring to FIG. 5, the internal structure of a nonvolatile me mory 500 is divided into a plurality of areas for storing different data. In the conventional technology, the substantial area of a nonvolatile memory 500 can be divided into two areas, a reserved area and a logic area. The reserved area includes a system information block 502, a firmware code block 504, an invalid block 506 and a reserved block 508. The logic area includes a master boot record (MBR) and a partition table (PT) block 510, a partition boot sector (PBS) block 512, a file allocation table block 514, a root directory block 516 and a data accessing block 518.

Conventionally, after the memory card is made, the manufacturer has to initialize the memory card with a special MP-tooling (usually provided by the manufacturer of the memory card controller). To initialize a memory card, related data including MBR, PT, PBS and system information are written to the nonvolatile memory, and a new nonvolatile memory may further includes an invalid block and a reserved block for substitution purpose.

Those who purchase conventional memory cards may encounter the incompatible problems so the data cannot be accessed or the memory card fails for unknown reasons. Memory cards still under warranty can be returned or repaired, but for memory cards with expired warranty, the buyer could only purchase a new card. However, returned merchandise would trouble the retailers and the rejected memory cards can only be returned back to the manufacturer for reinitializing process, which means repeating the initializing of the memory cards with the MP-tooling and rewriting the firmware, which is inconvenient and cost-wasting.

### SUMMARY OF THE INVENTION

An object of the present invention is to provide a method for updating firmware of a memory card, by which the user card can update the memory card using a PC or a card reader.

The present invention provides a method for updating firmware of a memory card, the memory card including at least a nonvolatile memory. The method includes the steps of: first, starting the memory card; then, determining whether there is a new firmware code in the nonvolatile memory; if it is determined that there is a new firmware code in the nonvolatile memory, then it is determined whether the new firmware code has been updated; if it is determined that the new firmware code has not been updated yet, then the firmware updating is performed, and then the general operating procedure of the memory card is performed.

According to an embodiment of the invention, whether there is a new firmware code or not in the nonvolatile memory is determined based on whether there is any specific file of the new firmware stored in the nonvolatile memory.

According to an embodiment of the invention, when it is determined that the new firmware code has been updated, then it is determined whether there is an old firmware code in the nonvolatile memory.

According to an embodiment of the invention, when it is determined that there is not any new firmware code in the nonvolatile memory, then it is determined whether there is any old firmware code in the nonvolatile memory. If it is determined that there is an old firmware code in the nonvolatile memory, then download the old firmware code and store in the RAM, thereafter process the general operating procedure of the memory card with the old firmware code.

According to an embodiment of the invention, when it is determined that there is not any old firmware code in the nonvolatile memory, a memory card initializing procedure is performed.

According to an embodiment of the invention, the procedure of updating the new firmware code further includes copying the old firmware code to a firmware code reserved area; copying the new firmware to the firmware area, and then resetting the memory card.

According to an embodiment of the invention, whether the new firmware code has been updated or not is determined based on the flag, the header, the version data, the file name, the sub file name and the file size of the new firmware.

According to the present invention, the new firmware is stored in the nonvolatile memory, therefore whenever the memory card is started, the new firmware code is searched in the nonvolatile memory or the file allocation table, such that the user can update the memory card using a PC or a card reader.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a flow chart for schematically illustrating a method for updating a firmware of a memory card according to an embodiment of the present invention.

FIG. 1B is a flow chart for schematically illustrating the procedure for updating the new firmware code according to an embodiment of the present invention.

FIG. 2 is a block diagram for schematically illustrating a circuit of the memory card and a mainframe according to an embodiment of the present invention.

FIG. 3 is a schematic diagram for illustrating the position of a specific file of a nonvolatile memory according to an embodiment of the present invention.

FIG. 4 is a schematic diagram for illustrating the format of a specific file of a nonvolatile memory according to an embodiment of the present invention.

FIG. 5 is a schematic structural diagram of a conventional nonvolatile memory.

### DESCRIPTION OF THE EMBODIMENTS

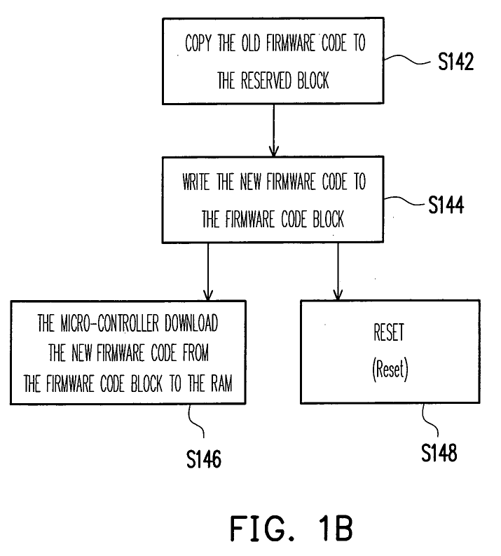

In order to explain the steps of the presently invented method for updating a firmware of a memory card, please refer to FIG. 2. FIG. 2 is a block diagram for schematically illustrating a circuit of the memory card and a mainframe according to a preferred embodiment. According to FIG. 2, a mainframe 202 is electrically coupled to a memory card 206 via a memory card bus 204, wherein those skilled in the relevant art would know that the mainframe 202 can be a card reader or a PC, and is not limited thereto.

According to an embodiment, the memory card 206 includes a host control unit 208, a nonvolatile memory interface 210 and a nonvolatile memory 212, wherein the interface of the nonvolatile memory is electrically connected with the host control unit 208 and the nonvolatile memory 212.

The host control unit 208 includes an input/output interface 214, a micro-controller 216, a RAM 218, a buffer 220 and a ROM 222. The micro-controller 216 is coupled to the nonvolatile memory interface 210, the input/output interface 214, the RAM 218, the buffer 220 and the ROM 222. The input/output interface 214 is electrically coupled to the memory card bus 204. According to the embodiment, the buffer 220 is adapted for temporarily storing the application program accessed by the micro-controller 216 from the RAM 218; the RAM 218 is adapted for storing the application program for the memory card 206; and the ROM 222 is adapted for storing the initialization programs for the memory card 206.

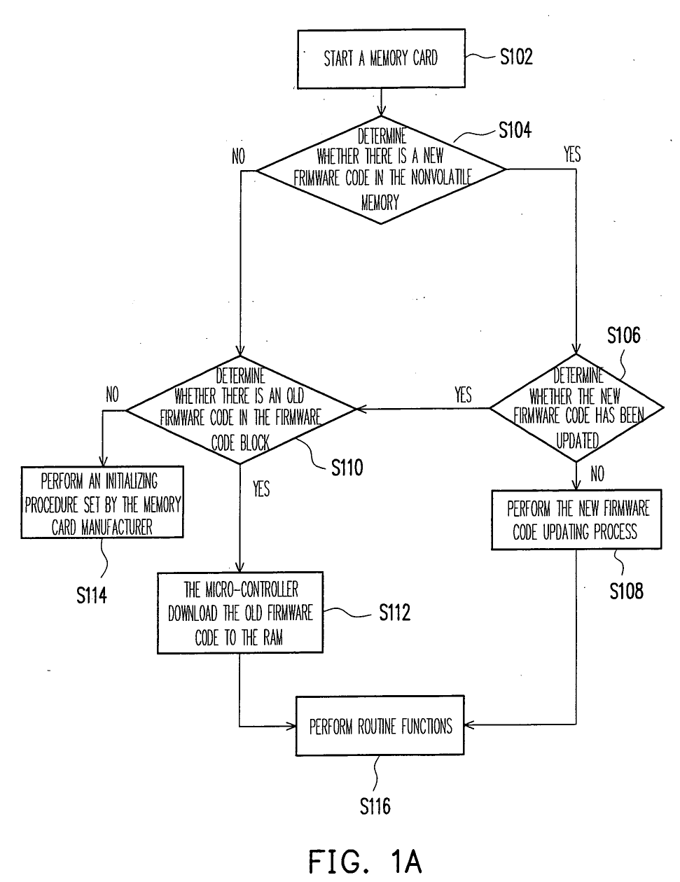

FIG. 1A is a flow chart for schematically illustrating a method for updating a firmware of a memory card according to an embodiment of the present invention. Referring to FIGS. 1A and 2, according to the embodiment, a method for updating a firmware of a memory card is as follows: start a memory card at step S102; then at step 104, a host control unit 208 searches for a new firmware code from the nonvolatile memory 212, wherein whether there is a new firmware code or not in the nonvolatile memory is determined based on whether there is any specific file of the new firmware stored in the nonvolatile memory.

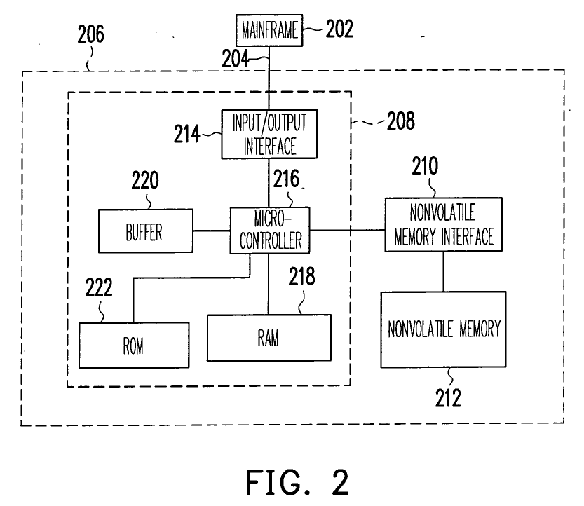

FIG. 3 is a schematic diagram for illustrating the position of a specific file of a nonvolatile memory according to an embodiment of the present invention, wherein for an easy explanation, only a part of the structure of the nonvolatile memory 212 is shown. Referring to FIG. 3, the nonvolatile memory 212 at least includes a firmware code block 302, a firmware code reserved block 304 and a data accessing block 306, the specific file 308 being stored in the data accessing block 306.

However, those skilled in the relevant art would know that whether there is specific file of a new firmware code in the nonvolatile memory can be determined by identifying the flag, header, the version data, the file name, the sub file name and the file size, but not limited thereto. If it is determined that there is not any new firmware code in the nonvolatile memory 212, then the step S110 is performed for determining. whether there is any old firmware code in the nonvolatile memory.

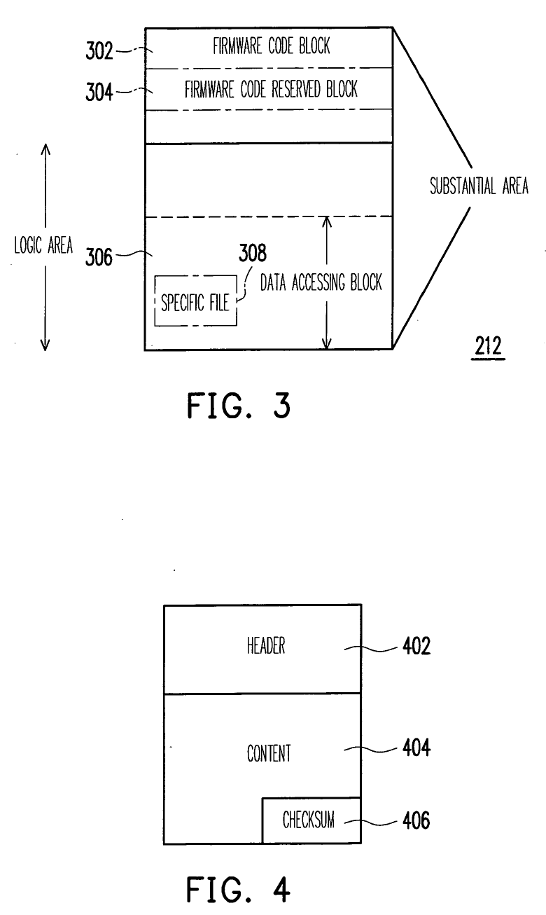

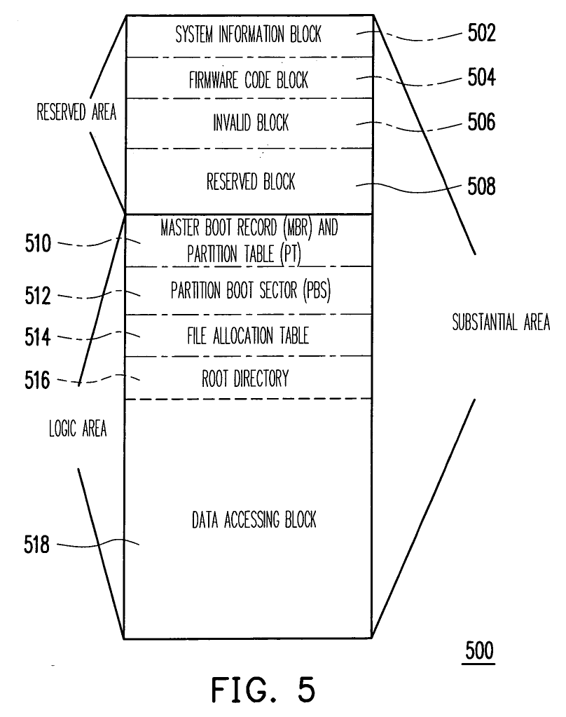

The formats of the specific files shown in FIG. 4 includes a header 402, a content 404 and a checksum 406. The header 402 includes a version data, a specific bar code provided for and to be identified by the micro-controller 216, and an updated flag (the application program is written into the flag after each updating process for avoiding repetitive use of the file after each resetting or starting process). The content 404 includes a firmware and the checksum 406 is for avoiding data errors.

Therefore, whether the new firmware code has been updated or not is determined based on the header or the version data of the firmware, but not limited thereto.

Referring to FIG. 1A, if it is determined that the new firmware code contains a specific file, then the step S106 is performed for determining whether the new firmware code has been updated. If it is determined that the new firmware code has not been updated yet, then step S108 is performed for updating the new firmware code. As shown in FIG. the procedure for updating the new firmware code includes the step S 142 for copying the old firmware code from the firmware code block 302 to the reserved block 304 and the step S144 for writing the new firmware code from the data accessing block 306 to the firmware code block 302.

Thereafter, at step S146, the micro-controller 216 downloads the new firmware code from the firmware code block 302 to the RAM 218 for the micro-controller operation. However, a step S148 may, instead of the step S146, follow the step S144 for resetting the memory card 206.

Again referring to FIG. 1A, if it is determined that there is not any new firmware code in the data accessing block 306, then a step S110 is performed for determining whether there is an old firmware code in the nonvolatile 212 or not. If it is determined that there is an old firmware code in the nonvolatile 212, then at step S112, the micro-controller 216 downloads the old firmware code from the firmware code block 302 to the RAM 218 for the micro-controller 216 operation. Then at step S116, the memory card 206 can process the routine functions of the general operating procedure.

Otherwise, if it is determined that there is not any old firmware code in the nonvolatile memory 212, then a step S114 of performing an initializing procedure set by the memory card manufacturer is performed.

At step S106, if it is determined that the new firmware code has been updated, then step S110 is performed for determining whether there is an old firmware code in the nonvolatile memory 212.

According to an embodiment of the invention, when the procedure for updating the new firmware code fails, a feedback indicator can be employed to inform the micro-controller 216 to restore the old firmware code in the firmware code reserved block 304 back to the firmware code block 302.

According to an embodiment of the invention, the header 402 includes a specific bar code for identification purpose, an updated flag and a version data.

According to an embodiment of the invention, the application program is written into the flag after updating each firmware code for avoiding repetitive use of the specific file after each resetting or starting process.

In summary, according to the presently invented method for updating a firmware of a memory card, any user, without a specific MP-tooling for reprocessing the initializing procedure, can conveniently download relevant files and update the newest version using a PC or any type of card reader.

Other modifications and adaptations of the above-described preferred embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A method for updating firmware of a memory card, the memory card at least including a nonvolatile memory and a RAM, the nonvolatile at least comprising a firmware code block and a firmware code reserved block; the method comprising:
starting the memory card;
determining whether there is a new firmware code or not and whether there is an old firmware code or not in the nonvolatile memory;
if itis determined that there is a new firmware code in the nonvolatile memory, determining whether the new firmware code has been updated;
if it is determined that the new firmware code has not been updated yet, updating the new firmware code as the firmware code; and
performing the general operating procedure of the memory card.

2. The method for updating firmware of a memory card according to claim 1, further comprising:
when it is determined that there is not any new firmware code in the nonvolatile memory, and if it is determined that there is an old firmware code in the nonvolatile memory, downloading and storing the old firmware code in the RAM; and
performing the general operating procedure of the memory card with the old firmware code.

3. The method for updating firmware of a memory card according to claim 2, further comprising:
if it is determined that there is not any old firmware code in the nonvolatile memory, performing a memory card initializing procedure.

4. The method for updating firmware of a memory card according to claim 1, wherein the procedure of updating the new firmware code further comprises:
if there is an old firmware code in the firmware code block, copying the old firmware code to a firmware code reserved area;
copying the new firmware to the firmware area; and
downloading the new firmware code from the firmware code block to a RAM.

5. The method for updating firmware of a memory card according to claim 1, wherein the procedure of updating the new firmware code further comprises:
if there is an old firmware code in the firmware code block, copying the old firmware code to a firmware code reserved area;
copying the new firmware to the firmware code block; and
resetting the memory card.

6. The method for updating firmware of a memory card according to claim 1, further comprising:
when the new firmware code has been updated, if there is an old firmware code in the firmware code block, downloading and storing the old firmware code to the RAM; if there is not any old firmware code in the firmware code block, performing a memory card initializing procedure set by the memory card manufacturer.

7. The method for updating firmware of a memory card according to claim 1, wherein determining whether these is the new firmware code or not and whether the new firmware code has been updated or not is determined based on a header of the new firmware code.

8. The method for updating firmware of a memory card according to claim 7, wherein the header comprises a specific bar code for identification purpose, an updated flag and a version data.

9. The method for updating firmware of a memory card according to claim 8, wherein the flag is updated after updating each new firmware code for avoiding repetitive use of the new firmware code after each resetting or starting process.

10. The method for updating firmware of a memory card according to claim 1, wherein determining whether these is the new firmware code or not and whether the new firmware code has been updated or not is determined based on a version data of the new firmware code.

11. The method for updating firmware of a memory card according to claim 1, wherein determining whether these is the new firmware code or not and whether the new firmware code has been updated or not is determined based on a file name of the new firmware code.

12. The method for updating firmware of a memory card according to claim 1, wherein determining whether these is the new firmware code or not and whether the new firmware code has been updated or not is determined based on a sub file name of the new firmware code.

13. The method for updating firmware of a memory card according to claim 1, wherein determining whether these is the new firmware code or not and whether the new firmware code has been updated or not is determined based on a file size of the new firmware code.

14. The method for updating firmware of a memory card according to claims 4, further comprising:
when the procedure for updating the new firmware code fails, employing an indicator to inform a micro-controller to restore the old firmware code in the firmware code reserved block back to the firmware code block.
